(19) United States
(12) Patent Application Publication
(10) Pub. No.: US 2025/0192893 A1
(43) Pub. Date: Jun. 12, 2025

(54) DIGITAL SIGNAL PROCESSING FOR BURST-MODE COHERENT OPTICAL PACKET DETECTION

(71) Applicant: Infinera Corp., San Jose, CA (US)

(72) Inventors: Syed Muhammad Bilal, Nuremberg (DE); Thomas Duthel, Nuremberg (DE); Christopher Fludger, Nuremberg (DE); Stenio Ranzini, Nuremberg (DE); Nikolai Soelch, Nuremberg (DE)

(21) Appl. No.: 18/972,009

(22) Filed: Dec. 6, 2024

Related U.S. Application Data
(60) Provisional application No. 63/607,671, filed on Dec. 8, 2023.

(51) Int. Cl. H04B 10/61; H04L 7/00

(52) U.S. Cl. CPC H04B 10/6164; H04B 10/6166; H04L 7/0075

(57) ABSTRACT

Methods and nodes including a hub node of a passive optical network (PON) comprising a DSP chain configured to: receive a signal burst from a leaf node in the PON, the signal burst having a frame comprising a payload and a frame header, the frame header comprising a clock-and-gain control section, a frame detection section, and an equalizer section; acquire a leaf node clock phase from the clock-and-gain control section of the frame header; estimate signal power of a signal burst from the leaf node in the PON; compensate for differences in the signal power of the signal burst from the leaf node; detect a Frame-Alignment-Sequence indicating arrival of the signal burst; determine MIMO polarization filter coefficients from the Frame-Alignment-Sequence; align a phase between X-Polarization and Y-Polarization of the signal burst using the MIMO polarization filter coefficients; and determine a local oscillator signal Frequency Offset Estimate (FOE).

### CROSS-REFERENCE TO RELATED APPLICATIONS

This application claims priority to the provisional patent application identified by U.S. Ser. No. 63/607,671, titled DIGITAL SIGNAL PROCESSING FOR BURST-MODE COHERENT OPTICAL PACKET DETECTION, filed Dec. 8, 2023, which is hereby expressly incorporated herein by reference.

### FIELD OF THE DISCLOSURE

The disclosure generally relates to methods and apparatuses for passive optical networks and coherent passive optical networks.

### BACKGROUND

Optical access networks have been evolving to accommodate the high bandwidth demand propelled by new emerging services such as 5G mobile internet, cloud networking, 8K/16K high quality video streaming applications, and Virtual/Augmented reality. Passive optical network (PON) technologies are widely deployed as low-cost solutions to meet such high capacity demands for the end users. Standard PON solutions are based on intensity modulated direct detection (IMDD) schemes. PONs based on time division multiplexing (TDM) mechanism are of particular interest as they not only save the wavelength resources but also reduce the associated cost and number of required optical components. However, standard passive optical networks are almost reaching their limit at 50 Gbps considering the required power budget. With ever increasing demand for higher transmission capacity, consequently, it is envisioned that 100 Gbps or even higher passive optical networks will be required, and that these may use coherent detection.

In a typical passive optical network, using digital subcarrier multiplexing (DSCM), each subcarrier of an N-subcarrier DSCM signal from hub optical line terminal (OLT) can be divided into M time slots to provide flexible bandwidth allocation for up to N×M access leaf optical network unit (ONU) subscribers.

Owing to the technology maturity and superior receiver sensitivity, coherent optics, which is traditionally being deployed for long-haul, metro, and data center transmission, have received considerable interest for access networks. It can be used as an attractive solution for the challenges faced by intensity modulated direct detection (IMDD) schemes which are limited by chromatic dispersion and spectral efficiency (typically electrical bandwidth efficiency). Using advanced modulation formats, digital dispersion compensation and equalizations enabled by digital signal processing (DSP), coherent-PON can provide much higher reach and larger network capacity.

However, coherent-PON still faces some challenges and many efforts have been made to overcome the cost and complexity obstacle of coherent optics in access networks.

Further, apart from cost and complexity, another key issue for coherent optics is how to effectively and robustly achieve coherent detection in upstream burst-mode direction.

In the downstream direction, signals are continuously broadcast to all users whereas the upstream of TDM-PON is in burst mode. Here, the user-side leaf ONUs are time synchronized so that they are able to interleave burst packets to the hub centralized OLT. The received upstream signals typically have different signal powers, are interleaved in time, have different clock timing, carrier phases and carrier frequency offsets and states of polarization (SOPs). For reliable upstream efficiency, the hub OLT must quickly respond to the burst signal and complete the acquisition within a short time, and reset itself to the next incoming upstream burst.

This burst mode detection is more challenging for coherent-PONs as compared to IMDD PONs as the information is modulated and multiplexed in phase, polarization, and amplitude dimensions. Conventional continuous mode coherent detection cannot be used for burst mode detection as it requires longer time to complete acquisition. This makes coherent-PON DSP more challenging, since all subsystems must act very fast to detect and acquire the short optical packet along with reliable frequency offset estimation (FOE). The convergence time of IM-DD DSP in the ITU-T standard of 50G-PON has been defined on the timescale of 100 ns. For 100 Gbps coherent-PON, acquisition times are in the order of several hundred nano-secs.

What is needed are systems and methods that facilitate the fast acquisition of a time division multiplexing (TDM) burst. With the inclusion of “coherent” for PON networks, faster and more reliable frame acquisition methods are needed.

### SUMMARY

Systems, nodes, and methods are disclosed including systems, nodes, and methods of quickly acquiring the clock phase; estimating and compensating for different signal power of bursts coming from different leaf-nodes (ONUs); robustly detecting the Frame-Alignment-Sequence indicating the arrival of a signal burst; determining the polarization MIMO filter coefficients from the Frame-Alignment-Sequence and aligning the phase between X-Pol & Y-Pol; determining a reliable local oscillator signal Frequency Offset Estimate (FOE); and/or applying/correcting the FOE. The systems, nodes, and methods disclosed provide fast and reliable frame acquisition for coherent passive optical networks.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1 is a schematic of an exemplary passive optical network in accordance with the present disclosure.

FIG. 1A is a schematic of an exemplary DSP chain in accordance with the present disclosure.

FIG. 2 is a schematic of an exemplary frame in accordance with the present disclosure.

FIG. 3 is a schematic of an exemplary passive optical network overlay method in accordance with the present disclosure.

FIG. 4 is a schematic of an exemplary clock recovery loop in accordance with the present disclosure.

FIG. 5 is a schematic of an exemplary phase detector in accordance with the present disclosure.

FIG. 6 is a graph illustrating lower and upper frequencies of a clock tone in accordance with the present disclosure.

FIG. 7 is a graph illustrating correlating lower and upper frequencies of a clock tone in accordance with the present disclosure.

FIG. 8 is a schematic of an exemplary state machine of a clock recovery step in accordance with the present disclosure.

FIG. 9A is a graph illustrating hypothetical received data in relation to the timing of fast tracking mode and slow tracking mode by a hub node in accordance with the present disclosure.

FIG. 9B is a graph illustrating hypothetical position of clock lock and detected burst inside the clock-and-gain control section of an exemplary frame in accordance with the present disclosure.

FIG. 9C is a graph illustrating hypothetical clock output phase in relation to the timing of fast tracking mode and slow tracking mode by a hub node in accordance with the present disclosure.

FIG. 9D is a graph illustrating hypothetical clock lock value and a false lock in relation to the timing of fast tracking mode and slow tracking mode by a hub node in accordance with the present disclosure.

FIG. 9E is a graph illustrating hypothetical clock tone power estimation in relation to the timing of fast tracking mode and slow tracking mode by a hub node in accordance with the present disclosure.

FIG. 9F is a graph illustrating hypothetical received signal power estimation in relation to the timing of fast tracking mode and slow tracking mode by a hub node in accordance with the present disclosure.

FIG. 10A is a graph illustrating an exemplary Finite State Machine (FSM) in accordance with the present disclosure.

FIG. 10B is a graph illustrating an input waveform in accordance with the present disclosure.

FIG. 10C is a graph illustrating gain calculated and applied at different points of the FSM in accordance with the present disclosure.

FIG. 10D is a graph illustrating a clock lock value in accordance with the present disclosure.

FIG. 10E is a graph illustrating a clock output phase in accordance with the present disclosure.

FIG. 10F is a graph illustrating clock tone power using IIR filter in accordance with the present disclosure.

FIG. 10G is a graph illustrating received signal power using IIR filter in accordance with the present disclosure.

FIG. 10H is a graph illustrating an output waveform in accordance with the present disclosure.

FIG. 11 is a schematic of an exemplary gain adjustment state machine in accordance with the present disclosure.

FIG. 12 is a schematic of an exemplary frame detector process in accordance with the present disclosure.

FIG. 13 is a graph of Monte Carlo simulations at different decision thresholds in accordance with the present disclosure.

FIG. 13A is an exemplary false frame detection probability graph in accordance with the present disclosure.

FIG. 13B is an exemplary graph showing probability of false detection for different lengths of symbols in accordance with the present disclosure.

FIG. 14 is a schematic of an exemplary frame detection process using hard decisions and soft decisions in accordance with the present disclosure.

FIG. 15 is a table of exemplary frequency offsets translated to rotation in degrees between consecutive symbols in accordance with the present disclosure.

FIG. 16A illustrates graphs of an example of cross correlation (XCorr) of received data for QPSK XPol and YPol (true detection) in accordance with the present disclosure.

FIG. 16B illustrates graphs of an example of cross correlation (XCorr) of received data for QPSK XPol and YPol (false detection) in accordance with the present disclosure.

FIG. 17 is a graph of exemplary numerical frame detection probability in accordance with the present disclosure.

FIG. 18A illustrates graphs of an example of different spin on X-Pol and Y-Pol after jump starting equalizer taps for 16QAM in accordance with the present disclosure.

FIG. 18B illustrates graphs of the same spin on X-Pol and Y-Pol after phase adjustment in accordance with the present disclosure.

FIG. 19A is a graph of an exemplary frequency offset estimation on X-Pol in accordance with the present disclosure.

FIG. 19B a graph of an exemplary frequency offset estimation on Y-Pol in accordance with the present disclosure.

### DETAILED DESCRIPTION

The following detailed description refers to the accompanying drawings. The same reference numbers in different drawings may identify the same or similar elements.

The mechanisms proposed in this disclosure circumvent the problems described above.

If used throughout the description and the drawings, the following short terms have the following meanings unless otherwise stated:

Rx stands for Receiver, which typically refers to optical channel receivers, but can also refer to circuit receivers.

Tx stands for Transmitter, which typically refers to optical channel transmitters, but can also refer to circuit transmitters.

### CDest Stands for Chromatic Dispersion Estimate.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

Further, the phrase “based on” is intended to mean “based, at least in part, on” unless explicitly stated otherwise.

Also, certain portions of the embodiments have been described as “components” or “circuitry” that perform one or more functions. The term “component” or “circuitry” may include hardware, such as a processor, an application specific integrated circuit (ASIC), or a field programmable gate array (FPGA), or a combination of hardware and software. Software includes one or more computer executable instructions that when executed by one or more component cause the component or circuitry to perform a specified function. It should be understood that the algorithms described herein are stored on one or more non-transient memory. Exemplary non-transient memory includes random access memory, read only memory, flash memory or the like. Such non-transient memory can be electrically based or optically based. Further, the messages described herein may be generated by the components and result in various physical transformations.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

In accordance with the present disclosure, messages transmitted between the nodes A-K, can be processed by circuitry within the input interface(s), and/or the output interface(s) and/or the control module. Circuitry could be analog and/or digital, components, or one or more suitably programmed microprocessors and associated hardware and software, or hardwired logic. Also, certain portions of the embodiments have been described as “components” that perform one or more functions. The term “component,” may include hardware, such as a processor, an application specific integrated circuit (ASIC), or a field programmable gate array (FPGA), or a combination of hardware and software.

Software includes one or more computer executable instructions that when executed by one or more component cause the component to perform a specified function. It should be understood that the algorithms described herein are stored on one or more non-transient memory. Exemplary non-transient memory includes random access memory, read only memory, flash memory or the like. Such non-transient memory can be electrically based or optically based. Further, the messages described herein may be generated by the components and result in various physical transformations.

Also, certain portions of the embodiments may have been described as “components” or “circuitry” that perform one or more functions. The term “component” or “circuitry” may include hardware, such as a processor, an application specific integrated circuit (ASIC), or a field programmable gate array (FPGA), or a combination of hardware and software.

Further, the phrase “based on” is intended to mean “based, at least in part, on” unless explicitly stated otherwise.

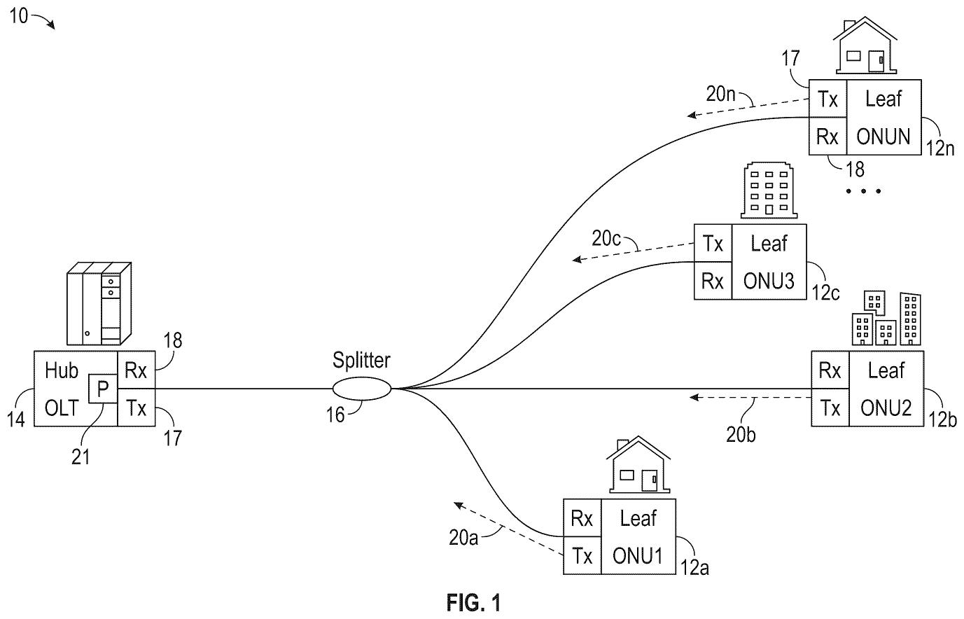

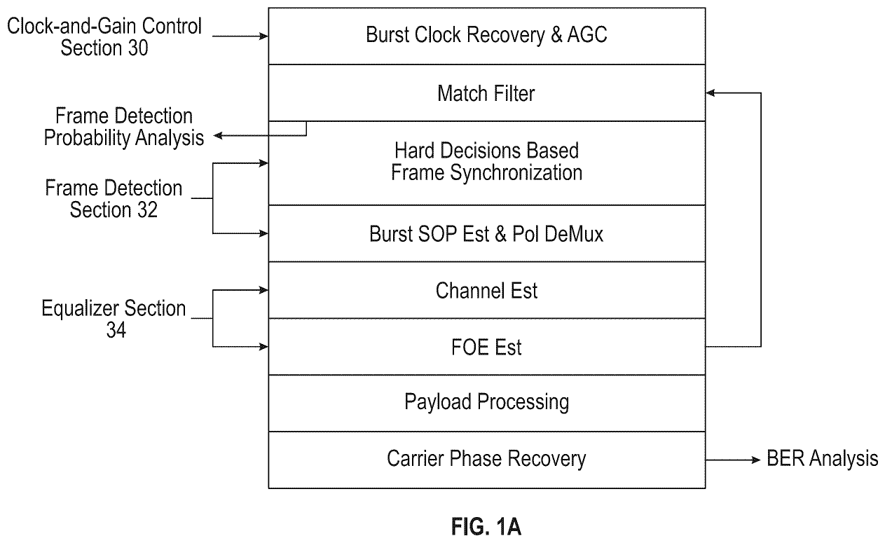

Referring now to the drawings, FIG. 1 is a schematic of an exemplary passive optical network (PON) 10. The passive optical network 10 may comprise one or more leaf nodes 12a, 12b, 12c . . . 12n (which may be referred to generally as leaf nodes 12 or as ONUs 12) and one or more hub node 14 (which may be referred to as an OLT 14) connected to the one or more leaf nodes 12 via one or more optical fibers. In the exemplary passive optical network (PON) 10, for explanatory purposes, the leaf nodes 12 are referred to as being “downstream” of the hub node 14 and the hub node 14 is referred to as being “upstream” of the leaf nodes 12. In some embodiments, the PON 10 may comprise one or more splitter 16 positioned between the hub node 14 and the one or more leaf nodes 12. The PON 10 may include more components, which are not shown for clarity.

The hub node 14 may include one or more transmitter (Tx) 17 for receiving signals from the one or more leaf nodes 12 and may include one or more receivers (Rx) 18 for sending signals to the one or more leaf nodes. The hub node 14 may include a digital signal processing (DSP) chain 19 for after analog-to-digital conversion (ADC) of a received signal at the hub node 14. The digital signal processing chain 19 may be carried out in the receiver 18 of the hub node 14. An exemplary DSP chain 19 is illustrated in FIG. 1A as applied to the nodes and methods described herein; however, because standard DSPs are well known to persons having ordinary skill in the art, the general structure of a standard DSP will not be further described herein.

The hub node 14 may include one or more processors 21. The processor 21 may be implemented as a single processor or multiple processors working together or independently to execute program logic and/or configured to carry out steps as described herein. It is to be understood that in certain embodiments using more than one processor 21, the processors 21 may be located remotely from one another, located in the same location, or comprising a unitary multi-core processor. The processors 21 may be capable of reading and/or executing processor executable code and/or capable of creating, manipulating, retrieving, altering, and/or storing data structures into nontransitory memory.

Exemplary embodiments of the processor 21 may include, but are not limited to, a digital signal processor (DSP), a central processing unit (CPU), a field programmable gate array (FPGA), a microprocessor, a multi-core processor, combinations, thereof, and/or the like, for example.

It should be understood that the hub node 14 and the one or more leaf nodes 12 can be implemented in a variety of manners including those shown and discussed in U.S. patent application No. 20090245289 entitled “Programmable Time Division Multiplexed Switching” the entire content of which is hereby incorporated herein by reference.

The passive optical network (PON) 10 has continuous downstream signals from the hub node 14 to the one or more leaf nodes 12, while upstream signals from the leaf nodes 12 to the hub node 14 are sent in bursts, that is, in pulses, upstream (which may be referred to herein as a signal burst). The bursts are synchronized so as not to interfere with one another. (Conventionally, the upstream signals were sent over a single channel upstream on the same wavelength.) The leaf nodes 12 each send data signals in the signal burst to the hub node 14 via a frame 20 (which may also be referred to as packet 20). The hub node 14 acquires the frame 20.

The processor 21 of the hub node 14 may process the frame 20 utilizing the DSP chain 19 after arrival of the signal burst.

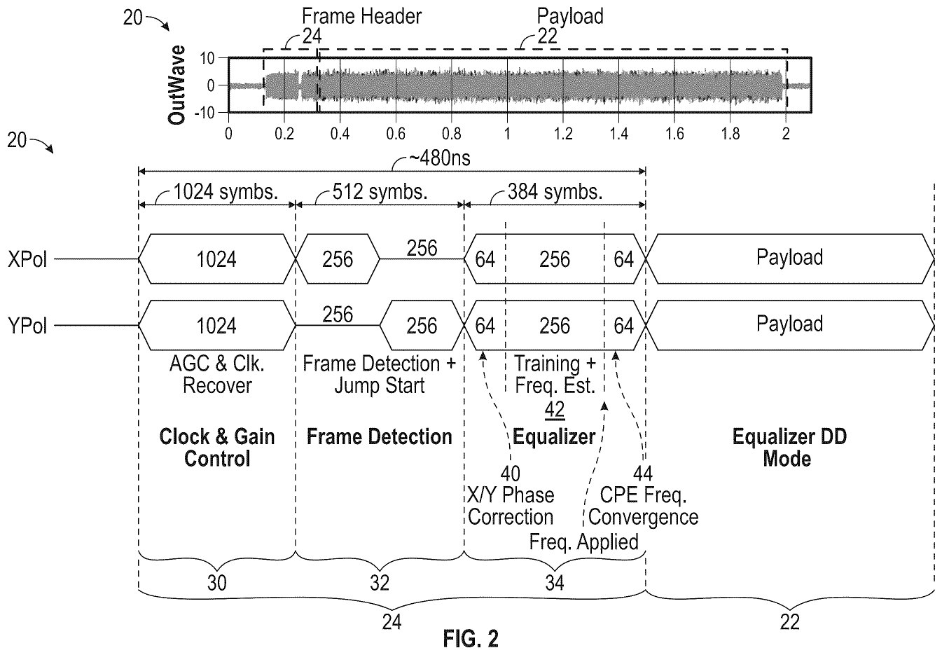

FIG. 2 illustrates an exemplary frame 20 as may be sent from an exemplary leaf node 12 to the hub node 14. The frame 20 includes payload 22 (which includes data traffic being transmitted) and includes a frame header 24. The frame header 24 is typically approximately 480 ns. The payload 22 is typically approximately three microseconds.

The frames 20 may be sent in signal bursts from the downstream leaf nodes 12 to the upstream hub node 14. That is, a first leaf node 12a may send a first frame 20a as a first signal burst, then a second leaf node 12b may send a second frame 20b as a second signal burst, then the third leaf node 12c may send a third frame 20c as a third signal burst, and the “n” leaf node 12n may send an N frame 20n as a N signal burst, and so on, sequentially in a timed order. The sequential order of the leaf nodes 12 each sending a corresponding frame 20 in a signal burst to the hub node 14 may be repeated.

The frame header 24 includes information for frame alignment. The frame header 24 may include a clock-and-gain control section 30, a frame detection section 32, and an equalizer section 34. The frame header 24 may have a length of 1920 symbols, which may correspond to an acquisition time of approximately 480 nsec for 4 GBaud systems (1920/4e9).

Each frame 20 may have different powers (error) which is indicated in the clock-and-gain control section 30 of the frame 20. The hub node 14 may compensate for error as indicated in the clock-and-gain control section 30 of the frame 20. In some embodiments, the clock-and-gain control section 30 may contain up to 1024 symbols. The clock-and-gain control section 30 of the frame 20 may be reserved for automatic gain control (AGC) and clock locking.

The frame detection section 32 of the frame 20 includes information for the hub node 14 to determine the existence of the frame 20 (the start of the frame 20) coming to the hub node 14. Further, the frame detection section may include “jump start” information that assists in estimating the tap weights of the polarization MIMO, which leads into the equalizer section 34 of the frame 20. In some embodiments, the frame detection section 32 may contain up to 512 symbols.

The equalizer section 34 may include subsections including a phase correction subsection 40 to align phase rotation between X-Pol & Y-Pol; an equalizer training phase and frequency offset estimation subsection 42; and a carrier phase estimator (CPE) frequency convergence subsection 44. In some embodiments, the equalizer section 34 may contain up to 384 symbols. The phase correction subsection 40 may contain up to 64 symbols. The equalizer training phase subsection and frequency offset estimation subsection 42 may contain up to 256 symbols. The CPE frequency convergence subsection 44 may contain up to 64 symbols.

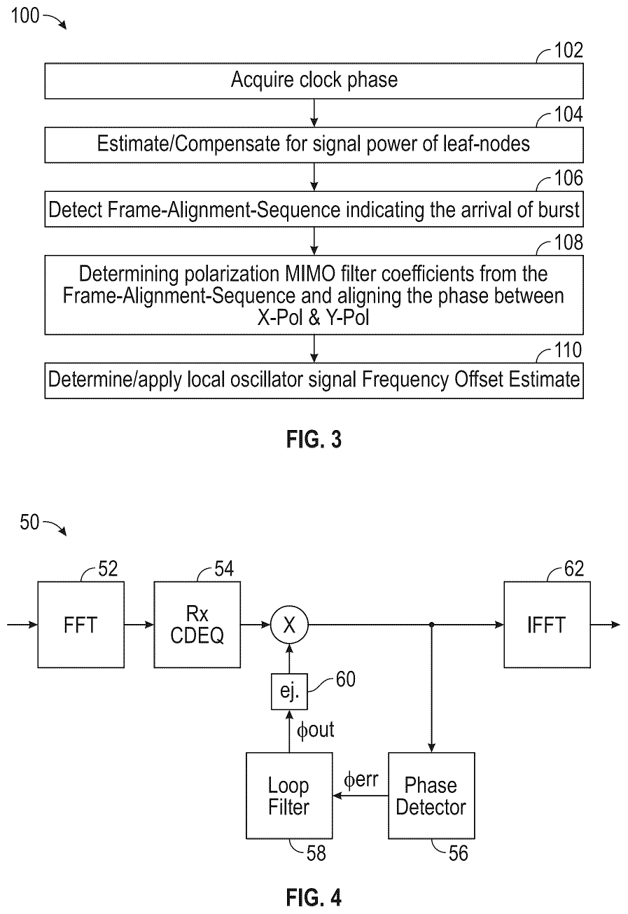

An exemplary PON overlay method 100 is illustrated in FIG. 3. The PON overlay method 100 may dedicate a specific wavelength (that is, a specific subcarrier) to a specific leaf node 12 for upstream communication to the hub node 14.

The PON overlay method 100 utilizes the acquisition of a frame 20 at the hub node 14 from a corresponding leaf node 12. In general, the PON overlay method 100 may include a step 102 of quickly acquiring the clock phase; a step 104 of estimating and compensating for different signal power of bursts coming from different ones of the leaf-nodes 12 (which may be referred to as ONUs); a step 106 of robustly detecting the Frame-Alignment-Sequence indicating the arrival of a signal burst; a step 108 of determining the polarization MIMO filter coefficients from the Frame-Alignment-Sequence and aligning the phase between X-Pol & Y-Pol; and a step 110 of determining a reliable local oscillator signal Frequency Offset Estimate (FOE) and/or applying the FOE correction.

In some embodiments, the PON overlay method 100 may be implemented within 480 ns.

In some embodiments, step 102 of acquiring the clock cycle may take eighteen nanoseconds to twenty nanoseconds. In step 102, the clock recovery may be a method for a coherent burst-mode receiver 18 in which the clock frequency offset has been resolved to a few parts-per-million (ppm) by locking the clock of the upstream signal from the leaf node 12 to the downstream signal from the hub node 14. Locking the signal can be done, for example, by tuning a VCO of the leaf node 12 and the hub node 14 directly, or pre-programming the numerically controlled oscillator (NCO) in a Rx-DSP of the leaf node 12 and the hub node 14.

The clock phase and small frequency difference may be detected during the initial part of the frame-alignment sequence (FAS) from the packet 20 in the hub node 14. The clock phase may be detected in the frequency domain by correlating upper and lower side-band frequencies at a frequency offset of the baud-rate, for each polarization, and then summing the resultant signals.

The clock-and-gain control section 30 may include clock header symbols comprise a series of alternating −1 and +1 symbols for strong tone detection, or similar sequence for 16QAM/QPSK transmission.

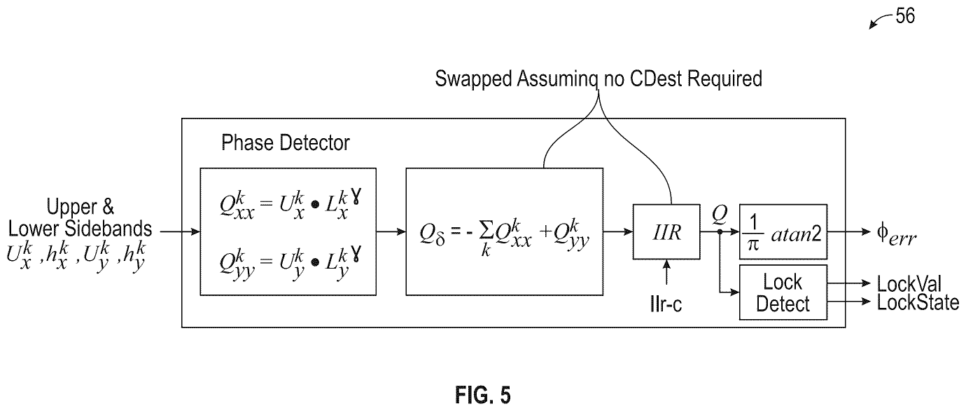

An example of a clock recovery loop 50 is shown in FIG. 4, including FFT 52, Rx-CDEQ 54, a trace-type phase detector 56, Loop Fitter 58, Phase Adjustment 60, and IFFT 62. An exemplary trace-type phase detector 56 is shown in more detail in FIG. 5. The phase detection may take place in the frequency domain after CD compensation (Rx-CDEQ 54). The trace-type phase detector 56 correlates upper and lower side-band frequencies, spaced by the baud-rate.

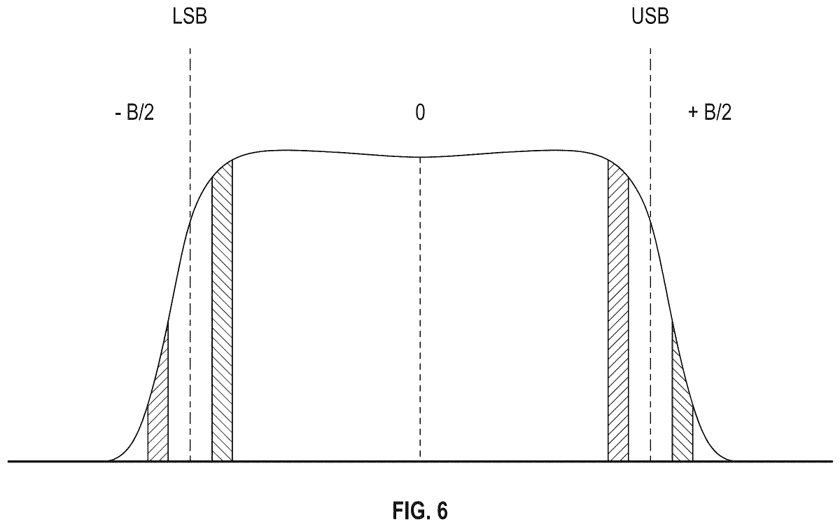

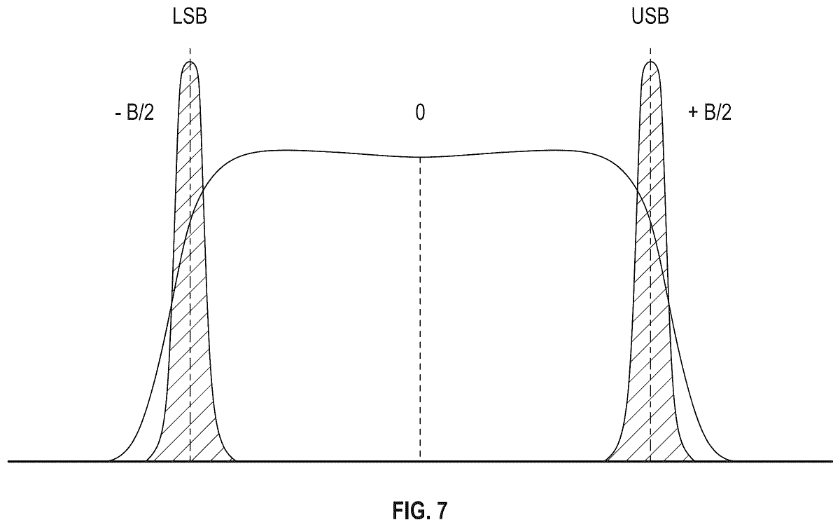

In the case of a +1, −1 sequence, the energy of the clock tone is very high and is ideal for initial clock locking, as illustrated in FIGS. 6 and 7. FIG. 6 illustrates correlating lower and upper frequencies. FIG. 7 illustrates strong clock tones from +1, −1 patterns. A strong clock tone increases the chances of the hub node locking onto the clock tone.

A “Determinant” version of the phase detector does not work with some input polarization states (SOP) when a preamble (such as frame header 24) is used. The trace-type phase detector 56 used in the clock recovery loop 50 is effective, so long as the DGD in the link is negligible (as it is in the PON 10). Clock frequency locking by adjusting the VCO of the ONU to lock to the OLT, or remembering the clock frequency offset from the last burst, is used for fast locking.

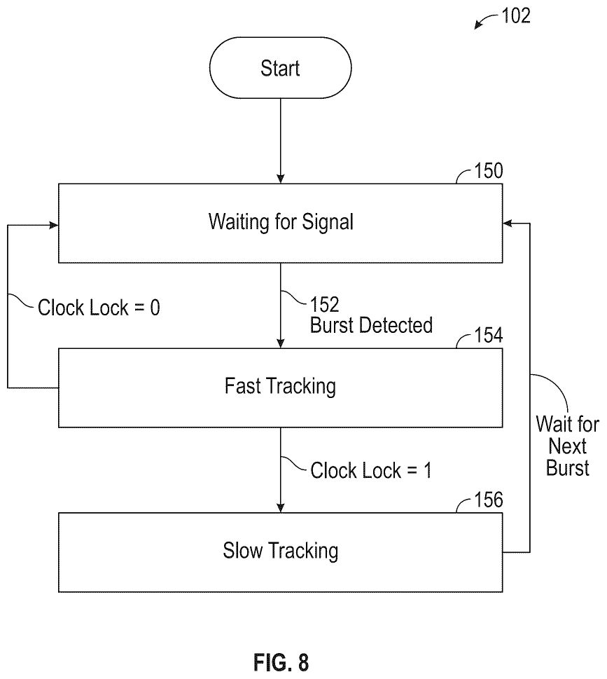

FIG. 8 is a schematic of a state machine of the clock recovery step 102. In a step 150, the hub node 14 waits for a signal from the leaf node 12, while observing input power and strength of the clock-tone. The receiver clock frequency may be pre-programmed with the clock frequency observations of the burst from a particular ONU 12. In one embodiment, the ONU clock of the leaf node 12 may be tuned to be the same, or a fixed offset from, the continuous downstream signal from the hub node 14.

When the hub node 14 detects a signal burst from the leaf node 12 in step 152, such as, for example, after both input power and clock tone exceed a predetermined threshold, then the hub node 14 moves to fast tracking mode in a step 154. In fast tracking mode, the clock loop filter is programmed for fast clock convergence, and the clock loop is closed.

If the hub node 14 detects that the clock is locked, then the hub node moves to a step 156 of slow tracking mode. The hub node 14 may stay for a predetermined number (N) of clock cycles (also referred to as “hold off time”) in fast tracking to allow convergence, and then switch to slow tracking mode after the clock phase is converged. Slow tracking mode uses clock loop filter coefficients programmed for slow changes so that the noise from the phase detector is better suppressed.

Once the burst is gone (that is, the signal is complete), the hub node 14 goes back to waiting for another signal (step 150).

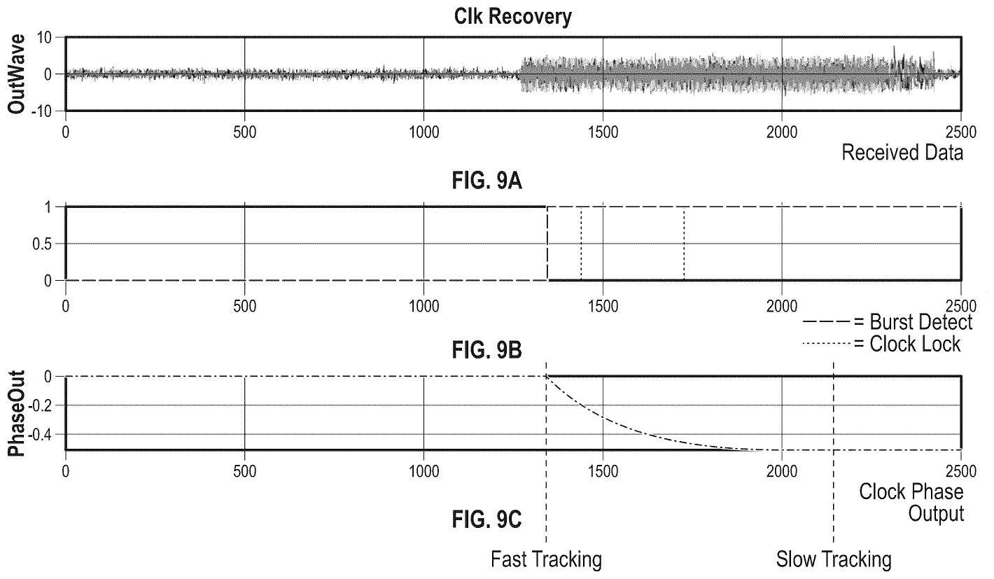

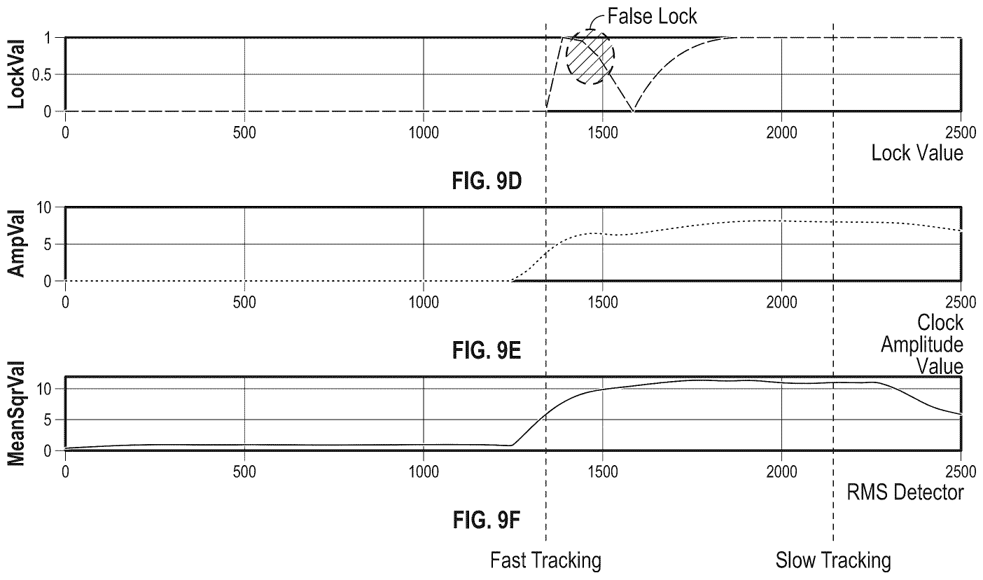

FIGS. 9A-9F illustrate hypothetical examples of different clock recovery outputs in relation to fast tracking mode and slow tracking mode during processing of the clock-and-gain control section 30 of the frame 20 by the hub node 14. The hold-off time also gives the clock recovery time to stabilize, ignoring false-lock points (shown) as the clock recovery performs “pull-in”. The power of the clock tone can also be used for gain-control. In fast tracking mode, the hub node 14 quickly pulls the clock in, in order to correctly determine the phase. In fast tracking mode, the hub node 14 switches on the clock recovery. Then, once the clock is locked, the hub node 14 switches to a slow tracking mode, with coefficients that are less noisy than coefficients used in fast tracking mode.

FIG. 9A illustrates Received Data in relation to the timing of fast tracking mode and slow tracking mode by the hub node 14. FIG. 9B illustrates the position of clock lock and detected burst inside the clock-and-gain control section 30 of the frame 20. FIG. 9C illustrates the clock output phase in relation to the timing of fast tracking mode and slow tracking mode by the hub node 14. FIG. 9D illustrates clock lock value (also showing a false lock) in relation to the timing of fast tracking mode and slow tracking mode by the hub node 14. FIG. 9E illustrates clock tone power estimation (which can be used for AGC) in relation to the timing of fast tracking mode and slow tracking mode by the hub node 14. FIG. 9F illustrates received signal power estimation (which can be used for AGC) in relation to the timing of fast tracking mode and slow tracking mode by the hub node 14.

The clock-and-gain control section 30 may be used by the hub node 14 for Automatic Gain Control (AGC) for coherent optical burst-mode receivers 18. The initial value of the gain may be set according to the power of the last packet payload from an individual leaf node 12, which may be referred to as the last-known-good gain value. The appropriate gain may be determined within the initial part of the frame header 24 by measuring the power of the clock tone from the clock phase detector.

The appropriate gain may be adjusted within the payload section 22 of the packet 20 using signal power estimation. The last-known-good gain value from a particular leaf node 12 may be updated and stored for future packets from that leaf node 12. The clock-and-gain control section 30 of the frame header 24 of the frame 20, as well as the payload section 22 of the frame 20 may be used for automatic gain control (AGC).

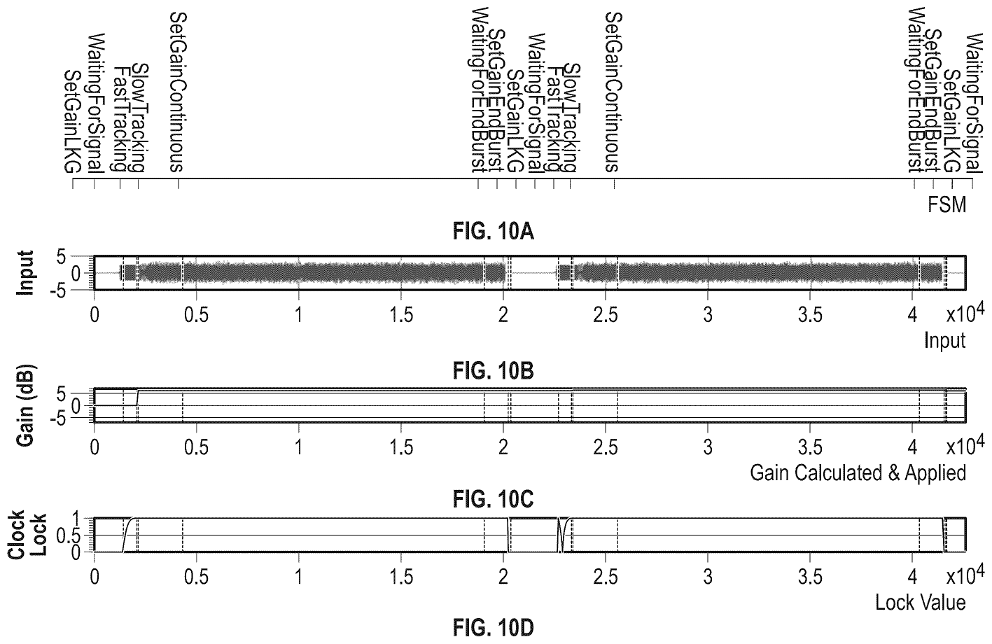

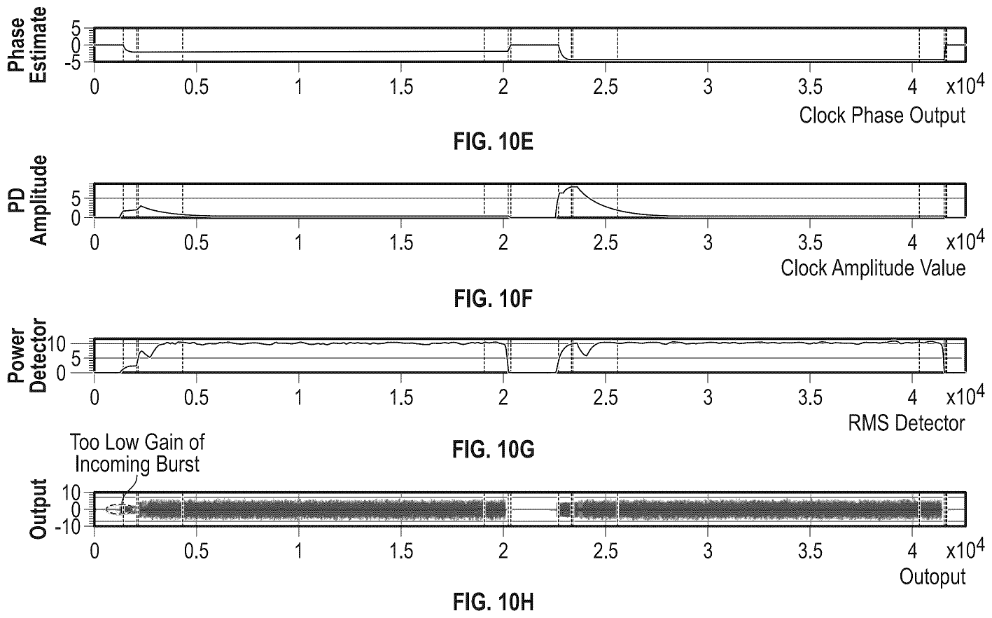

FIGS. 10A-10G illustrate a hypothetical example in which the gain of incoming signal is very low. FIG. 10A illustrates a Finite State Machine (FSM). FIG. 10B illustrates an Input waveform. FIG. 10C illustrates Gain calculated & applied at different points of the FSM. FIG. 10D illustrates a clock lock value. FIG. 10E illustrates a clock output phase. FIG. 10F illustrates clock tone power using IIR filter, which may be used for AGC inside clock-and-gain control section 30 of the frame header 24 of the frame 20. FIG. 10G illustrates received signal power using IIR filter, which may be used for continuous gain control inside the payload 22 of the frame 20 until the end of the burst (that is, the end of the received signal. FIG. 10H illustrates an output waveform.

As previously discussed, when a signal burst is detected, clock recovery may enter the fast tracking mode. In some embodiments, after holding-off for N clock cycles for convergence, the hub node 14 switches to the slow tracking mode. AGC does not change any coefficients for fast tracking mode or slow tracking modes. In some embodiments, gain is not adjusted during the fast tracking mode and is only adjusted, using the power estimate either from the average power of clock tone or signal, in the slow tracking mode (FIG. 10C).

FIG. 10F and FIG. 10G illustrate a plot of average clock tone and signal power using an IIR filter, respectively. During the payload, the signal power and the gain are continuously estimated and updated, respectively. The last known good (LKG) gain value may be saved as a reference for adjusting the gain of the next incoming burst from a particular ONU 12. This process is independent and records different gain values for each ONU 12.

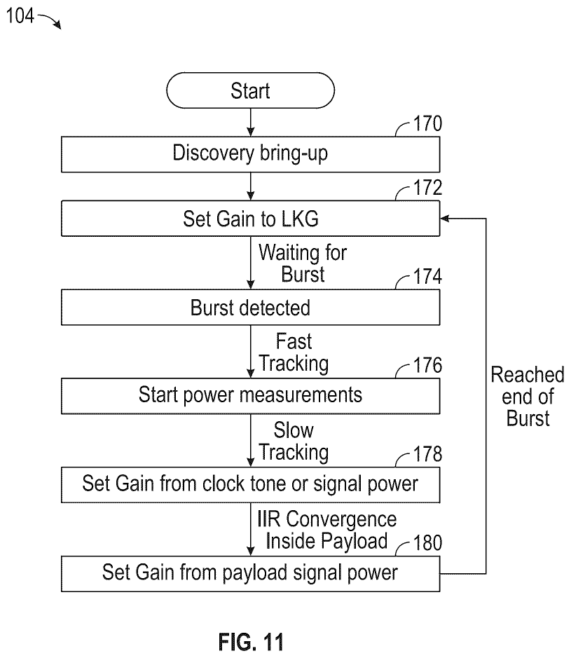

FIG. 11 illustrates an example of a gain adjustment state machine illustrating step 104, for estimating and compensating for different signal power of bursts coming from different leaf-nodes (ONUs) 12. The gain is calculated to give the desired power (dependent on modulation format). Power measurements may be calculated by the hub node 14 from clock-tone/signal power inside the clock-and-gain control section 30 of the frame header 24 of the frame 20, or measurements of the rms power from the payload 22. The sequence of events are as follows.

As shown, a step 170 is a “Discovery” bring-up phase. The discovery bring-up phase may be used, for example, the first time the hub node 14 is plugged-in and/or powered-up. Processing of signal bursts may not begin immediately. The hub node 14 may go through a “transient” phase once activated when signal bursts are received using, for example, a firmware state machine, before the hub node 14 begins processing, that is, before the hub node 14 begins detecting packets 20 and processing the frame header 24 and the payload 22 of the packets 20. The discovery bring-up phase may not be used in some instances, for example, if the hub node 14 is already in use.

From the discovery bring-up phase, the hub node 14 sets the gain to the LKG gain value in a step 172. The LKG gain value is from a particular leaf node 12 and is calculated separately for each leaf node 12. In a step 174, a burst from the leaf node 12 is detected by the hub node 14.

In a step 176, the hub node 14 measures the power during the fast clock recovery mode after burst detection.

In a step 178, the hub node 14 sets the gain from the clock tone or signal power when clock is locked, and goes into the slow tracking mode.

In a step 180, the hub node 14 may continuously measure the power after IIR convergence during the payload 22 of the burst and update the gain value. The hub node 14 may store the LKG gain value for a particular leaf node 12 to be used for the next burst from that particular leaf node 12.

Returning to FIG. 3, in the PON overlay method 100, step 106 comprises a frame detector of the hub node 14 for coherent optical burst-mode receivers 18, in which the hub node 14 robustly detects the Frame-Alignment-Sequence (FAS) indicating the arrival of a burst from a particular leaf node 12. If the hub node 14 does not detect the packet 20, then the packet 20 is dropped. The frame-alignment sequence (FAS) includes interleaved symbols of a known pattern, and the scrambled version of the known pattern in the frame detection section 32 of the frame header 24 of the frame 20. The frame detector de-interleaves and descrambles the received sequence, and then cross correlates the two received sequences (that is, the known pattern with the “descrambled” version). The sum of the correlation may be used as a soft-decision to indicate the presence of the Frame-Alignment-Sequence (FAS). A hard-decision may then be used to give a more reliable decision to indicate the presence of the Frame-Alignment-Sequence (FAS), unlike soft-decision based frame-detectors conventionally used.

The overall FAS length in the frame detection section 32 of the frame header 24 of the frame 20 is 512 symbols and includes a pattern on one polarization followed by the second polarization (i.e. one at a time, as shown in FIG. 2 in the frame detection section 32). The Frame-Alignment-Sequence may be utilized to obtain an initial estimate of MIMO tap weights. Effectively, there are 128 known original symbols on each polarization. These symbols are scrambled and interleaved to form 256 FAS symbols (at a time, as shown in FIG. 2 in the frame detection section 32) for each polarization.

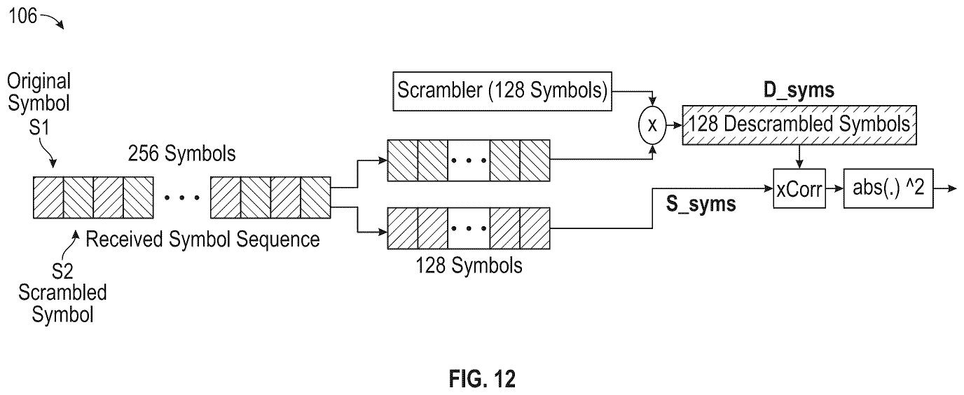

As shown in FIG. 12, at the receiver 18 of the hub node 14, as part of step 106, the frame detector de-interleaves odd and even symbols representing the original symbols S1 and scrambled symbols S2 (not all of which are marked in the figure for clarity). The scrambled symbols are descrambled by multiplication with a scrambler sequence giving D_syms. This data is further cross-correlated with the original deinterleaved symbols (S_syms). The sum of the correlation (peak) may be used as a soft-decision to indicate the presence of the FAS. This soft detection method is independent of polarization states (SOP) and takes place without separating X-Pol and Y-Pol.

Frame detection for access networks is the same as cross correlating the incoming signal with the known Frame-Alignment-Sequence (FAS) and detecting the correlation peak. However, these soft-decisions become highly unreliable if the incoming signal has some gain variation (e.g., ±1 dB). Transmit power control and receiver automatic-gain-control (AGC) may minimize the power variation, though a good gain tolerance improves the robustness of packet detection from geographically diverse leaf nodes 12. The power of the correlation peak depends upon the scaling/power of the input signal. A packet 20 can be falsely detected just by increasing the signal power such that noise or random correlations become large enough to trigger the “Packet-detect” by increasing the correlation peak power above the detection threshold. This is termed a false-positive result. On the other hand, if due to gain variations scaling/power of the input signal become too small, correlation peak power will become too low to go above the detection threshold. “Packet-detect” will not be triggered. This is termed a false-negative result.

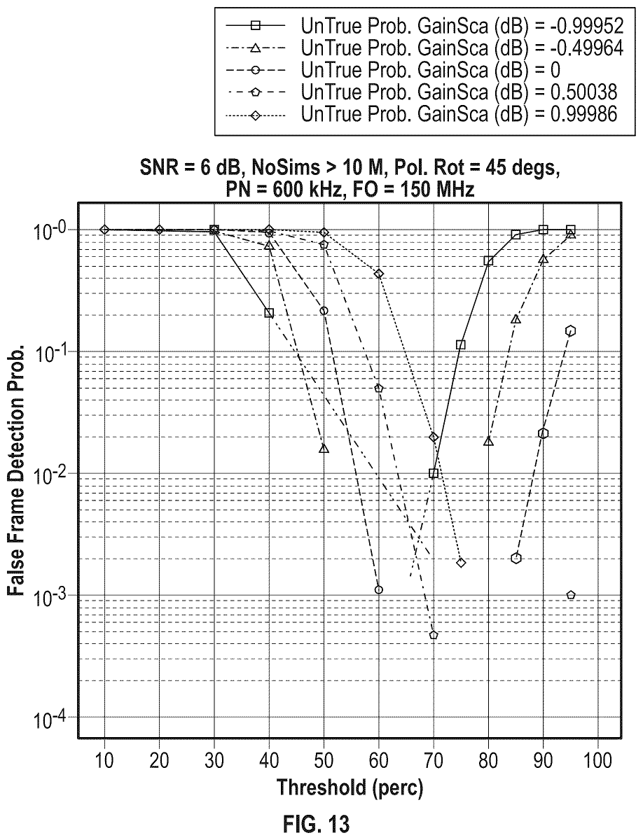

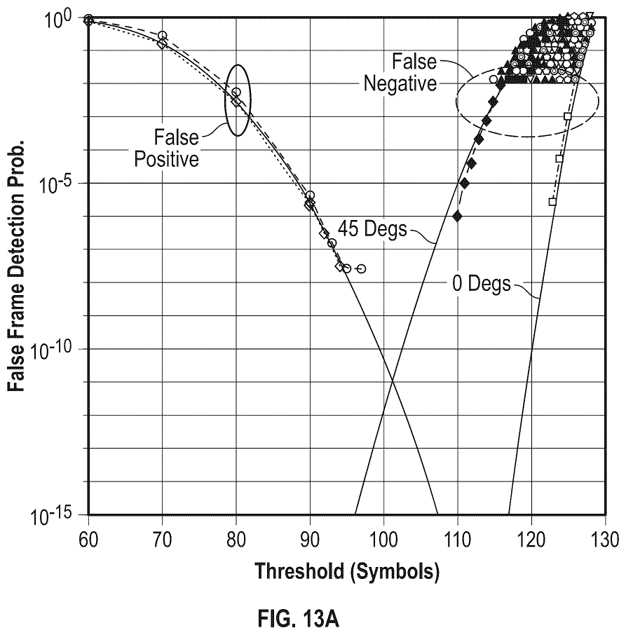

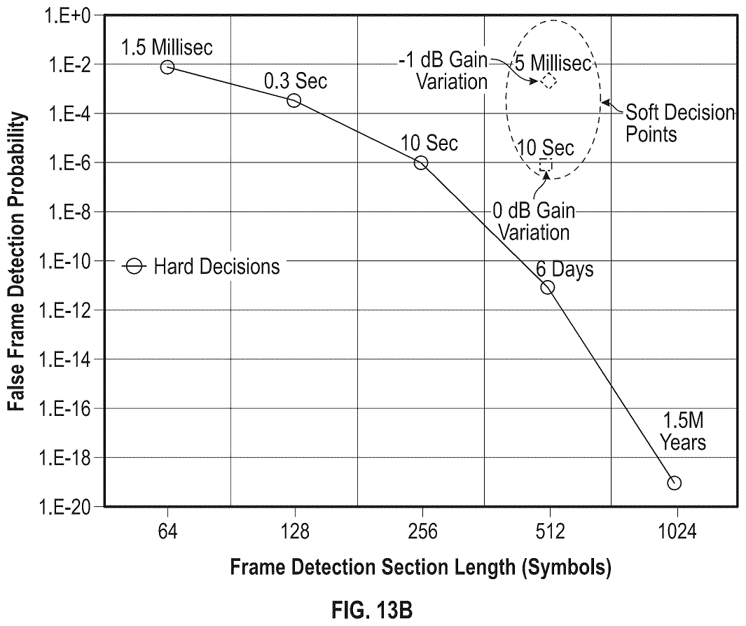

FIG. 13 gives an example of Monte Carlo simulations for QPSK for false/untrue frame detection probability at different decision thresholds. Left hand curves indicate a false negative (no frame detected given the frame is there) and right-hand curves indicate false positive (frame detected given no frame is there). Results for-1 dB gain variation are extrapolated to show that false frame detection probability is quite high (>1e-3). More than 10 million simulations are done for an SNR=6 dB (FEC threshold for QPSK), phase noise (PN)=600 kHz, frequency offset (FO)=150 MHz and polarization mixing (Pol. Rot)=45 degrees between X-Pol. & Y-Pol. It is worth noting that in a PON scenario, there may be 256,000 to 1M packets in a single second, so packet detection needs to be highly reliable.

FIG. 13A gives an example of false frame detection probability for a length of the frame detection section 32 of 512 symbols (2×2×128 scrambled and interleaved symbols on two polarizations). Numerical curves are obtained from analytical equations, simulative curves are obtained by performing more than 35M Monte-Carlo simulations with SOP, SNR of 6 dB, phase noise of 600 kHz and laser frequency offset of 150 MHz. Experimental analysis was done on more than 100 captures each having different polarization rotation.

For numerical analysis, false positive probability can be calculated as the probability that the expected pattern randomly appears in the received data:

$${P}_{false + ive} = {\sum }_{r = 0}^{nerr} ( \begin{matrix}N \\ r\end{matrix} ) {{P}_{e}^{r} ( 1 - {P}_{e} )}^{N - r}$$

where N and nerr=128 (the original symbols in the frame detection section 32) and Pₑ=0.5 (equally likely). Note that this is independent of any impairments.

False negative probability would be:

$${P}_{false - ive} = 1 - {\sum }_{r = 0}^{nerr} ( \begin{matrix}N \\ r\end{matrix} ) {{P}_{e}^{{′}^{r}} ( 1 - {P}_{e}^{′} )}^{N - r}$$

P′ₑ for false negative would be dependent on noise (6 dB SNR) and polarization mixing. In particular, 0 degree SOP rotations represent the base case, and 45 degree the worst-case, which determines the detection threshold. FIG. 13A shows the two bounds with experimental results falling in-between. With a threshold of 105 symbols, false detection occurs with a probability of approximately 10-11, or approximately once every six days.

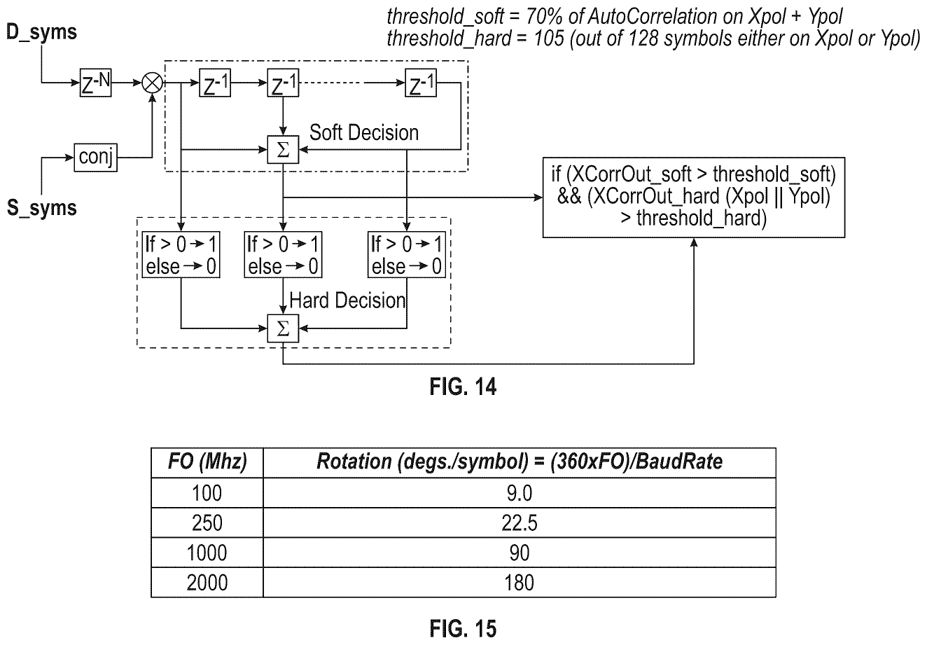

FIG. 13B shows the probability of false detection for different lengths of symbols in the frame detection section 32 of the frame 20. “Soft Decisions” detection scheme (that is, −1 dB gain variation shown with a diamond point and 0 dB gain variation shown with a square point in the graph of FIG. 13B) misses frames every five msec and ten seconds, respectively. “Hard Decisions” detection scheme is several orders of magnitude more robust, giving a missing frame every approximately six days for the same synchronization pattern length. The use of the hard-decision detector results in achieving the high tolerance to gain variations such as might be seen in burst-mode PON systems 10. The frequency offset is within tolerable range for frequency variations between bursts. In order to have reliable frame detection, the PON overlay method 100 utilizes frequency offset tolerant hard decisions on top of soft decisions, as illustrated in FIG. 14.

The effect of a frequency offset is to rotate the correlated symbols by a phase. The tolerance to frequency offset is a result of the use of consecutive correlated symbols for hard decisions, as shown in the table in FIG. 15. The table in FIG. 15 shows frequency offset (in MHz) translated to rotation in degrees between consecutive symbols for 4 GBaud.

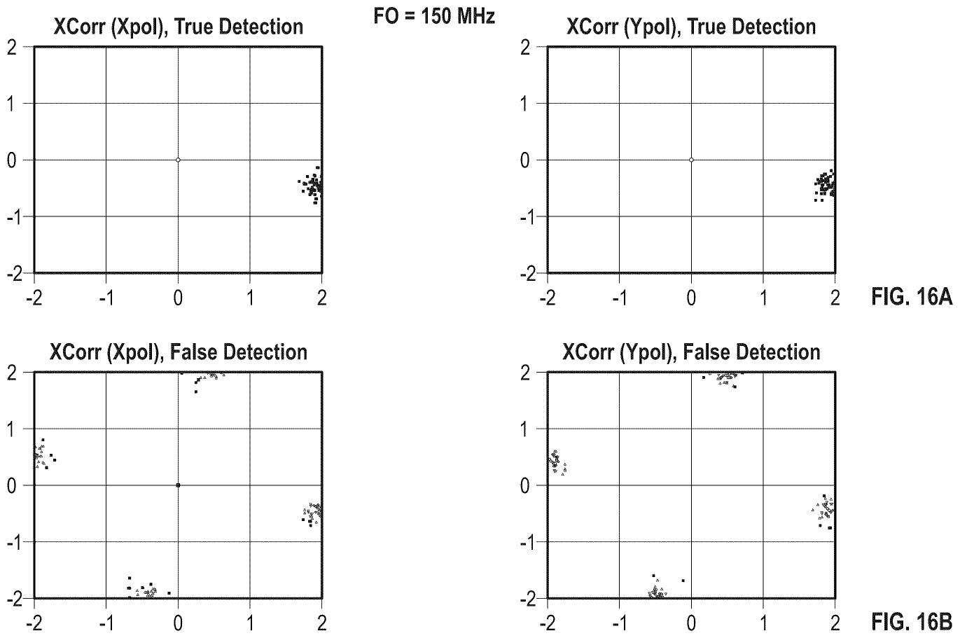

FIGS. 16A and 16B gives an example of cross correlation (XCorr) of received data with known FAS for a FO=150 MHz for QPSK. FIG. 16A shows an example of XCorr between FAS symbols (true detection). Rotation can be seen for the correlated symbols as calculated in the table of FIG. 15. Setting a hard decision threshold at ‘x>0’ (see FIG. 14) and making symbol-by-symbol hard decisions and summing them up, reliable frame detection can be obtained. Signal power variation will not change the number of hard decisions that are correct/incorrect. FIG. 16B shows an example of XCorr of non-FAS data with known FAS. Hard decisions correct/incorrect detection probability is approximately 50% for false detections.

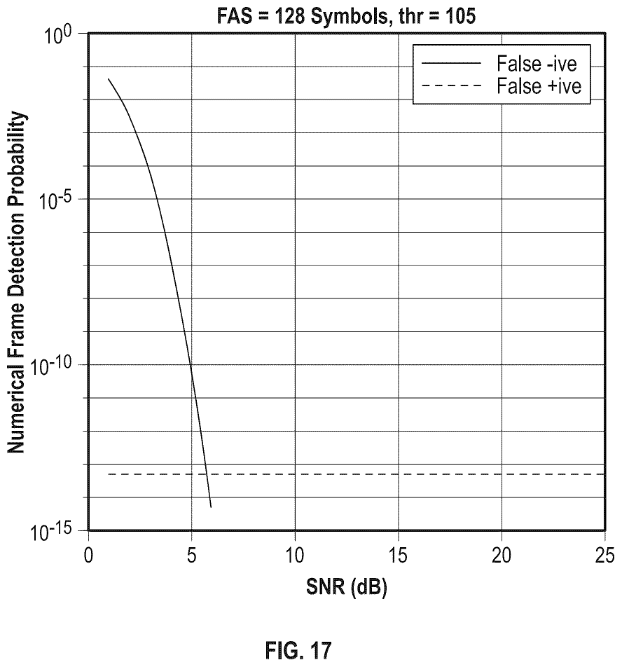

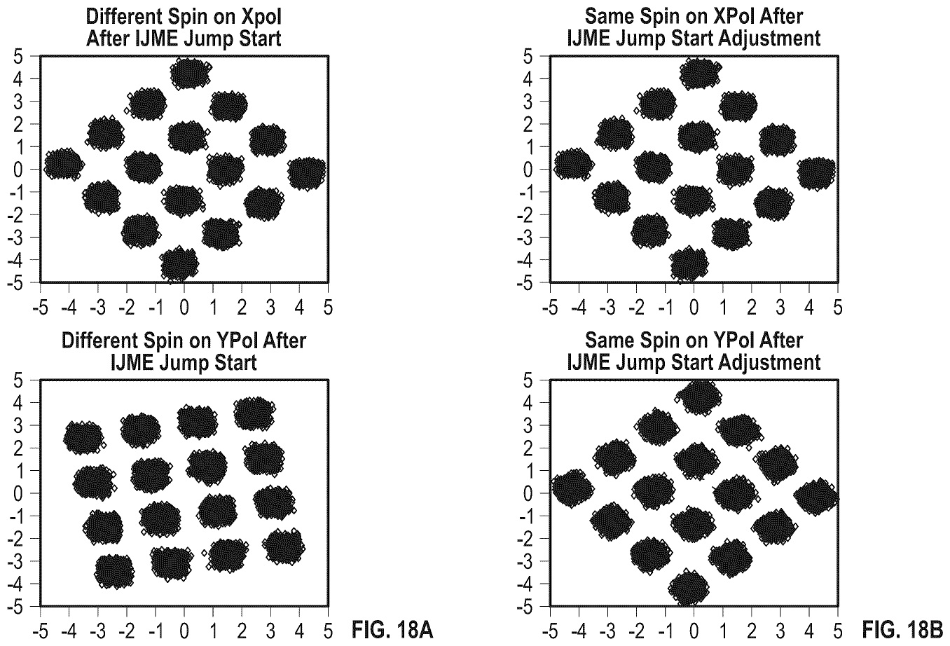

FIG. 17 gives an example of numerical frame detection probability for a FAS length of 128 symbols (that is, the original symbols in the frame detection section 32, FIG. 2) for both false positive and false negative for a 16QAM system. By properly setting the hard decision threshold, false frame detection probability can be reduced down to approximately 1e-15.

Returning to FIG. 3, step 108 of the PON overlay method 100 involves determining the polarization MIMO filter coefficients from the Frame-Alignment-Sequence and aligning the phase between X-Pol and Y-Pol. The step 106 of the PON overlay method 100 may include equalizer jump start and phase adjustment. Jump starting the polarization MIMO filter for a coherent burst-mode receiver 18 of the hub node 14 may use a training sequence comprising a pattern of a first polarization followed by a second polarization (i.e., one at a time, as shown in the frame detection section 32 of the frame header 24 of the frame 20 in FIG. 2).

This may be used for an initial estimate of the MIMO tap weights, which might have an arbitrary phase rotation between them.

The training sequence may be followed by another known training sequence on both polarizations. This can resolve the phase rotation between two polarizations (as shown in the equalizer section 34 of the frame header 24 of the frame 20 in FIG. 2).

Using the training sequences resolves the phase difference between polarizations so that a single carrier phase estimator (CPE) for both polarizations can be used. This reduces complexity of the CPE, and improves the tolerance to phase noise.

Due to fast acquisition needed for burst mode detection, equalizer taps must converge very quickly. This can be done by estimating the channel Inverse Jones Matrix. After inverse jones matrix estimation (IJME) using the equalizer section 34 of the frame header 24 of the frame 20, as shown in FIG. 2, equalizer taps can be “jump-started” for faster convergence. However, these “jump started” taps can cause different phase rotations on X-Polarization & Y-Polarization and would require separate carrier phase estimation (CPE). In order to improve the phase noise estimation accuracy and to enable the use of a single CPE estimator, additional training symbols (the first 64 symbols of the equalizer section 34 of the frame header 24 of the frame 20, as shown in FIG. 2) may be used. The relative phase difference between X-Pol and Y-Pol can be calculated by multiplying X-Pol and Y-Pol symbols with the conjugate of known Y-Pol symbols.

$${rx}_{vec} = {x}_{r} [ n ] * conj ( {y}_{r} [ n ] )$$

$${tx}_{vec} = {x}_{t} [ n ] * conj ( {y}_{t} [ n ] )$$

where, rx_{vec} and tx_{vec} are calculated from received and transmitted FAS on X-Pol (xᵣ, xₜ) and Y-Pol (yᵣ, yₜ), respectively.

The phase difference between the two polarizations may be calculated using:

$$diff = angle {\sum }_{n = 0}^{63} {rx}_{vec} [ n ] * conj ( {tx}_{vec} [ n ] )$$

After calculating the phase difference, Y-Pol taps of LMS2×2 equalizer may be rotated to have same spin on both polarizations:

$${h}_{YPol}^{′} = {h}_{YPol} * exp ( + jdiff )$$

Since xₜ and yₜ are known transmitted symbols, conjugate of tx_{vec} can be stored as a look-up table (LUT) to save power and complexity. Otherwise, the relative phase difference between X-Pol and Y-Pol can also be calculated by multiplying X-Pol and Y-Pol symbols with the conjugate of known X-Pol and Y-Pol symbols, respectively.

$${rx}_{vec} = {x}_{r} [ n ] * conj ( {y}_{r} [ n ] )$$

$${tx}_{vec} = {x}_{t} [ n ] * conj ( {y}_{t} [ n ] )$$

$$diff = angle {\sum }_{n = 0}^{63} {rx}_{vec} * conj ( {tx}_{vec} [ n ] ) = angle {\sum }_{n = 0}^{63} {x}_{r} [ n ] * conj ( {y}_{r} [ n ] ) * conj ( {x}_{t} [ n ] * conj ( {y}_{t} [ n ] ) ) = angle {\sum }_{n = 0}^{63} {x}_{r} [ n ] * conj ( {x}_{t} [ n ] ) * conj ( {y}_{r} [ n ] * conj ( {y}_{t} [ n ] ) )$$

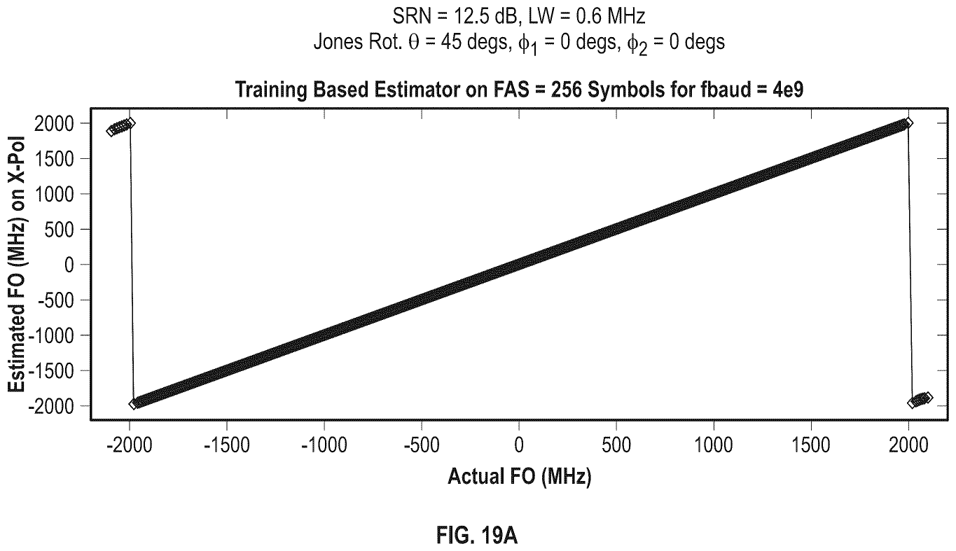

FIG. 18A gives an example of different spin on X-Pol and Y-Pol after jump starting the equalizer taps for 16QAM. Phase is adjusted between the two polarizations (as shown in FIG. 18B) using the first 64 symbols of the equalizer section 34 of the frame header 24 of the frame 20 (as shown in FIG. 2). This allows averaging of estimated phase between the two polarizations, improves phase noise estimation accuracy and enables use of a single CPE estimator. The next 256 and 64 symbols of the equalizer section 34 of the frame header 24 may be used for more accurate convergence of equalizer taps and CPE frequency convergence, respectively.

Returning to FIG. 3, step 110 of the PON overlay method 100 involves determining a reliable local oscillator signal Frequency Offset Estimate (FOE) utilizing a local-oscillator signal (Lo-Sig) frequency recovery circuit. The phase vector between the received signal and the known FAS is calculated. The instantaneous frequency is calculated from the phase difference between consecutive phase vectors. The average frequency offset is calculated by averaging the instantaneous frequency offset over the FAS. Since the received symbols after IJME jump start are already equalized, frequency offset (FO) can be reliably estimated by using the second part (256 symbols) of the equalizer section 34 of the frame header 24 of the frame 20 (as shown in FIG. 2):

$$phs\_vec [ n ] = {r}_{x} [ n ] * conj ( {t}_{x} [ n ] )$$

$$FO = ( \frac{BaudRate}{2 π} ) angle ( \frac{1}{N} {\sum }_{n = 1}^{N} phs\_vec [ n ] * conj ( phs\_vec [ n - 1 ] ) )$$

where N=256, and rₓ and tₓ are the received and known transmitted FAS symbols, respectively.

Additionally, different FOE methods are available, such as detecting the frequency tone and/or doing maximum likelihood FOE, which may be used.

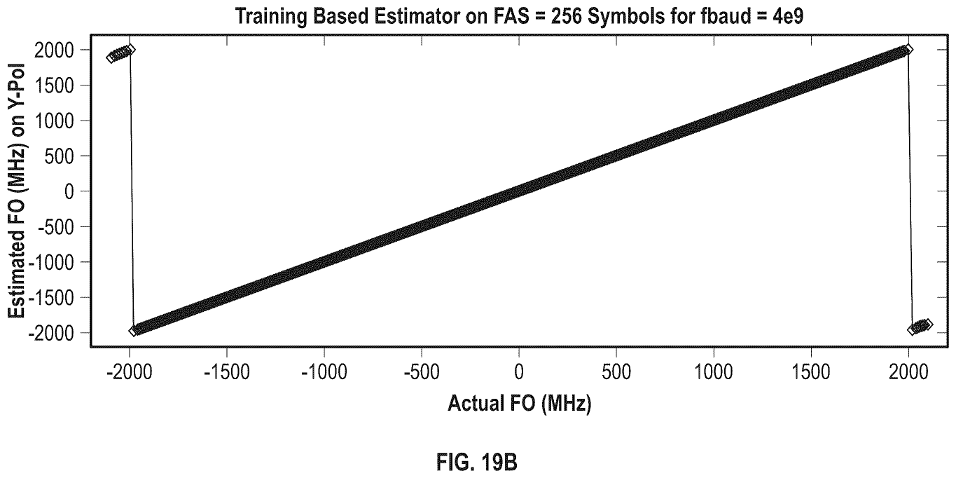

Step 110 uses the FAS to determine the frequency offset of the signal burst from the leaf node 12. This can reliably estimate FOE within frequency offset range of ±Fs/2 (Fs being the sample rate). For example, FIGS. 19A and 19B illustrate the FOE accuracy for a 16QAM, 4 GBaud system with SNR=12.5 dB (FEC threshold), PN=600 kHz and 45 degree polarization mixing between X-Pol & Y-Pol. FIG. 19A illustrates X-Pol FO estimation and FIG. 19B illustrates Y-Pol FO estimation. Once the FOE is determined, it may be applied for correction. For example, as shown in FIG. 1A, the FOE may be reported back to a Matched Filter for use for correction.

The following is a numbered list of non-limiting exemplary illustrative clauses:

Clause 1. A method, comprising: receiving, with a hub node of a passive optical network, a signal burst from a leaf node in the passive optical network, the signal burst having a frame comprising a payload and a frame header, the frame header comprising a clock-and-gain control section, a frame detection section, and an equalizer section; acquiring, with the hub node, a clock phase of the leaf node from the clock-and-gain control section of the frame header; estimating, with the hub node, signal power of a signal burst from the leaf node in the passive optical network; compensating, with the hub node, for differences in the signal power of the signal burst from the leaf node; detecting, with the hub node, a Frame-Alignment-Sequence indicating arrival of the signal burst; determining, with the hub node, multiple input, multiple output (MIMO) polarization filter coefficients from the Frame-Alignment-Sequence; aligning, with the hub node, a phase between X-Polarization and Y-Polarization of the signal burst using the MIMO polarization filter coefficients; and determining, with the hub node, a local oscillator signal Frequency Offset Estimate (FOE).

Clause 2. The method of Clause 1, comprising: applying the determined Frequency Offset Estimate.

Clause 2a. The method of Clause 2, wherein applying the determined Frequency Offset Estimate utilizes a matched filter.

Clause 3. The method of any of Clauses 1, 2, and 2a, wherein the frame header has a length up to 480 ns.

Clause 3a. The method of any of Clauses 1, 2, 2a, and 3, wherein the payload of the frame has a length up to three microseconds.

Clause 4. The method of any of Clauses 1, 2, 2a, 3, and 3a, wherein the clock-and-gain control section is configured to contain up to 1024 symbols.

Clause 5. The method of any of Clauses 1-4, wherein the frame detection section of the frame header is configured to contain up to 512 symbols.

Clause 6. The method of any of Clauses 1-5, wherein the frame detection section of the frame includes information for the hub node to determine an existence of the frame coming to the hub node.

Clause 7. The method of any of Clauses 1-6, wherein the equalizer section of the frame header is configured to contain up to 384 symbols.

Clause 8. The method of any of Clauses 1-7, wherein the equalizer section of the frame comprises a phase correction subsection; an equalizer training phase and frequency offset estimation subsection; and a carrier phase estimator (CPE) frequency convergence subsection.

Clause 9. The method of Clause 8, wherein the phase correction subsection is configured to contain up to sixty-four symbols, the equalizer training phase subsection is configured to contain up to 256 symbols; and/or the frequency offset estimation and CPE frequency convergence subsection is configured to contain up to sixty-four symbols.

Clause 10. The method of any of Clauses 1-9, where acquiring, with the hub node, the clock phase of the leaf node from the clock-and-gain control section of the frame header comprises a trace-type phase detector in the hub node carrying out the following: locking the clock of the signal burst to a downstream signal from the hub node; and correlating upper and lower side-band frequencies at a frequency offset of a baud-rate for each polarization then summing resultant signals.

Clause 11. The method of any of Clauses 1-10, where acquiring, with the hub node, the clock phase of the leaf node from the clock-and-gain control section of the frame header comprises a trace-type phase detector in the hub node carrying out the following after detecting the signal burst: moving to fast tracking mode in which a clock loop filter is programed for fast clock convergence and a clock loop is closed; detecting that the clock is locked; moving to slow tracking mode in which clock loop filter coefficients programmed for slow changes are used; and once the signal burst is complete, waiting for a second signal burst.

Clause 12. The method of any of Clauses 1-11, wherein estimating, with the hub node, signal power of the signal burst from the leaf node and compensating, with the hub node, for differences in the signal power of the signal burst comprises: setting gain to a last-known-good gain value for the leaf node; measuring the signal power during a fast clock recover mode after detection of the signal burst; setting the gain; going into slow tracking mode; measuring the signal power during the payload of the frame; and updating the gain value.

Clause 13. The method of any of Clauses 1-12, wherein detecting, with the hub node, the Frame-Alignment-Sequence indicating the arrival of the signal burst comprises, utilizing a frame detector to: deinterleave and descramble a sequence of symbols in the frame detection section of the frame header; cross-correlate the sequence of symbols with a known pattern of symbols; and utilize a sum of the cross-correlation as a soft-decision to indicate a presence of frame-alignment-sequence.

Clause 14. The method of Clauses 1-13, wherein determining, with the hub node, the local oscillator signal Frequency Offset Estimate (FOE), utilizes a local-oscillator signal (Lo-Sig) frequency recovery circuit which is configured to: calculate a phase vector between the signal burst and a known frame-alignment-sequence; calculate an instantaneous frequency from a phase difference between consecutive phase vectors; and calculate an average frequency offset by averaging the instantaneous frequency offset over the frame-alignment-sequence.

Clause 15. A hub node of a passive optical network, the hub node comprising a digital signal processing (DSP) chain configured to: receive a signal burst from a leaf node in the passive optical network, the signal burst having a frame comprising a payload and a frame header, the frame header comprising a clock-and-gain control section, a frame detection section, and an equalizer section; acquire a clock phase of the leaf node from the clock-and-gain control section of the frame header; estimate signal power of a signal burst from the leaf node in the passive optical network; compensate for differences in the signal power of the signal burst from the leaf node; detect a Frame-Alignment-Sequence indicating arrival of the signal burst; determine multiple input, multiple output (MIMO) polarization filter coefficients from the Frame-Alignment-Sequence; align a phase between X-Polarization and Y-Polarization of the signal burst using the MIMO polarization filter coefficients; and determine a local oscillator signal Frequency Offset Estimate (FOE).

Clause 15a. The hub node of Clause 15, the hub node comprising a digital signal processing (DSP) chain configured to apply the determined Frequency Offset Estimate.

Clause 15b. The hub node of Clause 15, wherein the DSP chain comprises a matched filter, and wherein applying the determined Frequency Offset Estimate utilizes the matched filter.

Clause 16. The hub node of any of Clauses 15, 15a, and 15b, wherein the equalizer section of the frame comprises a phase correction subsection; an equalizer training phase and frequency offset estimation subsection; and a carrier phase estimator (CPE) frequency convergence subsection.

Clause 16a. The hub node of Clause 16, wherein the phase correction subsection is configured to contain up to sixty-four symbols, the equalizer training phase subsection is configured to contain up to 256 symbols; and/or the frequency offset estimation and CPE frequency convergence subsection is configured to contain up to sixty-four symbols.

Clause 17. The hub node of any of Clauses 15-16, wherein the clock phase of the leaf node from the clock-and-gain control section of the frame header comprises a trace-type phase detector configured to carry out the following: locking the clock of the signal burst to a downstream signal from the hub node; and correlating upper and lower side-band frequencies at a frequency offset of a baud-rate for each polarization then summing resultant signals.

Clause 18. The hub node of any of Clauses 15-17, wherein the hub node comprises a trace-type phase detector configured to carry out the following for acquiring the clock phase of the leaf node from the clock-and-gain control section of the frame header after detecting the signal burst: moving to fast tracking mode in which a clock loop filter is programed for fast clock convergence and a clock loop is closed; detecting that the clock is locked; moving to slow tracking mode in which clock loop filter coefficients programmed for slow changes are used; and once the signal burst is complete, waiting for a second signal burst.

Clause 19. The hub node of any of Clauses 15-18, wherein estimating signal power of the signal burst from the leaf node and compensating for differences in the signal power of the signal burst comprises: setting gain to a last-known-good gain value for the leaf node; measuring the signal power during a fast clock recover mode after detection of the signal burst; setting the gain; going into slow tracking mode; measuring the signal power during the payload of the frame; and updating the gain value.

Clause 20. The hub node of any of Clauses 15-19, wherein determining the local oscillator signal Frequency Offset Estimate (FOE), utilizes a local-oscillator signal (Lo-Sig) frequency recovery circuit of the hub node which is configured to: calculate a phase vector between the signal burst and a known frame-alignment-sequence; calculate an instantaneous frequency from a phase difference between consecutive phase vectors; and calculate an average frequency offset by averaging the instantaneous frequency offset over the frame-alignment-sequence.

Clause 21. The hub node of any of Clauses 15-20, wherein the frame header has a length up to 480 ns.

Clause 22. The hub node of any of Clauses 15-21, wherein the payload of the frame has a length up to three microseconds.

Clause 23. The hub node of any of Clauses 15-22, wherein the clock-and-gain control section is configured to contain up to 1024 symbols.

Clause 24. The hub node of any of Clauses 15-23, wherein the frame detection section of the frame header is configured to contain up to 512 symbols.

Clause 25. The hub node of any of Clauses 15-24, wherein the frame detection section of the frame includes information for the hub node to determine an existence of the frame coming to the hub node.

Clause 26. The hub node of any of Clauses 15-25, wherein the equalizer section of the frame header is configured to contain up to 384 symbols.

Clause 27. The hub node of any of Clauses 15-26, wherein detecting the Frame-Alignment-Sequence indicating the arrival of the signal burst comprises, utilizing a frame detector to: deinterleave and descramble a sequence of symbols in the frame detection section of the frame header; cross-correlate the sequence of symbols with a known pattern of symbols; and utilize a sum of the cross-correlation as a soft-decision to indicate a presence of frame-alignment-sequence.

### CONCLUSION

Conventionally, there are problems with achieving coherent detection in upstream burst-mode direction in passive optical networks. In accordance with the present disclosure, nodes and methods are disclosed that are configured to accommodate the fast-growing market of coherent passive optical networks (CPONs) for access networks to accommodate high surge in bandwidth demand. The systems, nodes, and methods disclosed provide fast and reliable frame acquisition for coherent passive optical networks.

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Further, while embodiments have been described in the context of an optical network, this need not be the case. These embodiments may apply to an electronic network using copper cabling, or even a wireless network.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set and in the exemplary clauses listed above.

No element, act, or instruction used in the present application should be construed as critical or essential to the invention unless explicitly described as such outside of the preferred embodiment.

What is claimed is:

1. A method, comprising:
receiving, with a hub node of a passive optical network, a signal burst from a leaf node in the passive optical network, the signal burst having a frame comprising a payload and a frame header, the frame header comprising a clock-and-gain control section, a frame detection section, and an equalizer section;
acquiring, with the hub node, a clock phase of the leaf node from the clock-and-gain control section of the frame header;
estimating, with the hub node, signal power of a signal burst from the leaf node in the passive optical network;
compensating, with the hub node, for differences in the signal power of the signal burst from the leaf node;
detecting, with the hub node, a Frame-Alignment-Sequence indicating arrival of the signal burst;
determining, with the hub node, multiple input, multiple output (MIMO) polarization filter coefficients from the Frame-Alignment-Sequence;
aligning, with the hub node, a phase between X-Polarization and Y-Polarization of the signal burst using the MIMO polarization filter coefficients; and
determining, with the hub node, a local oscillator signal Frequency Offset Estimate (FOE).

2. The method of claim 1, comprising:
applying the determined Frequency Offset Estimate.

3. The method of claim 1, wherein the frame header has a length up to 480 ns and the payload of the frame has a length up to three microseconds.

4. The method of claim 1, wherein the clock-and-gain control section is configured to contain up to 1024 symbols.

5. The method of claim 1, wherein the frame detection section of the frame header is configured to contain up to 512 symbols.

6. The method of claim 1, wherein the frame detection section of the frame includes information for the hub node to determine an existence of the frame coming to the hub node.

7. The method of claim 1, wherein the equalizer section of the frame header is configured to contain up to 384 symbols.

8. The method of claim 1, wherein the equalizer section of the frame comprises a phase correction subsection; an equalizer training phase and frequency offset estimation subsection; and a carrier phase estimator (CPE) frequency convergence subsection.

9. The method of claim 8, wherein the phase correction subsection is configured to contain up to sixty-four symbols, the equalizer training phase subsection is configured to contain up to 256 symbols; and the frequency offset estimation and CPE frequency convergence subsection is configured to contain up to sixty-four symbols.

10. The method of claim 1, where acquiring, with the hub node, the clock phase of the leaf node from the clock-and-gain control section of the frame header comprises a trace-type phase detector in the hub node carrying out the following:
locking the clock of the signal burst to a downstream signal from the hub node; and
correlating upper and lower side-band frequencies at a frequency offset of a baud-rate for each polarization then summing resultant signals.

11. The method of claim 1, where acquiring, with the hub node, the clock phase of the leaf node from the clock-and-gain control section of the frame header comprises a trace-type phase detector in the hub node carrying out the following after detecting the signal burst:
moving to fast tracking mode in which a clock loop filter is programed for fast clock convergence and a clock loop is closed;
detecting that the clock is locked;
moving to slow tracking mode in which clock loop filter coefficients programmed for slow changes are used; and
once the signal burst is complete, waiting for a second signal burst.

12. The method of claim 1, wherein estimating, with the hub node, signal power of the signal burst from the leaf node and compensating, with the hub node, for differences in the signal power of the signal burst comprises:
setting gain to a last-known-good gain value for the leaf node;
measuring the signal power during a fast clock recover mode after detection of the signal burst;
setting the gain;
going into slow tracking mode;
measuring the signal power during the payload of the frame; and
updating the gain value.

13. The method of claim 1, wherein detecting, with the hub node, the Frame-Alignment-Sequence indicating the arrival of the signal burst comprises, utilizing a frame detector to:
deinterleave and descramble a sequence of symbols in the frame detection section of the frame header;
cross-correlate the sequence of symbols with a known pattern of symbols; and
utilize a sum of the cross-correlation as a soft-decision to indicate a presence of frame-alignment-sequence.

14. The method of claim 1, wherein determining, with the hub node, the local oscillator signal Frequency Offset Estimate (FOE), utilizes a local-oscillator signal (Lo-Sig) frequency recovery circuit which is configured to:
calculate a phase vector between the signal burst and a known frame-alignment-sequence;
calculate an instantaneous frequency from a phase difference between consecutive phase vectors; and
calculate an average frequency offset by averaging the instantaneous frequency offset over the frame-alignment-sequence.

15. A hub node of a passive optical network, the hub node comprising a digital signal processing (DSP) chain configured to:
receive a signal burst from a leaf node in the passive optical network, the signal burst having a frame comprising a payload and a frame header, the frame header comprising a clock-and-gain control section, a frame detection section, and an equalizer section;
acquire a clock phase of the leaf node from the clock-and-gain control section of the frame header;
estimate signal power of a signal burst from the leaf node in the passive optical network;
compensate for differences in the signal power of the signal burst from the leaf node;
detect a Frame-Alignment-Sequence indicating arrival of the signal burst;
determine multiple input, multiple output (MIMO) polarization filter coefficients from the Frame-Alignment-Sequence;
align a phase between X-Polarization and Y-Polarization of the signal burst using the MIMO polarization filter coefficients; and
determine a local oscillator signal Frequency Offset Estimate (FOE).

16. The hub node of claim 15, wherein the equalizer section of the frame comprises a phase correction subsection; an equalizer training phase and frequency offset estimation subsection; and a carrier phase estimator (CPE) frequency convergence subsection.

17. The hub node of claim 15, wherein the clock phase of the leaf node from the clock-and-gain control section of the frame header comprises a trace-type phase detector configured to carry out the following:
locking the clock of the signal burst to a downstream signal from the hub node; and
correlating upper and lower side-band frequencies at a frequency offset of a baud-rate for each polarization then summing resultant signals.

18. The hub node of claim 15, wherein the hub node comprises a trace-type phase detector configured to carry out the following for acquiring the clock phase of the leaf node from the clock-and-gain control section of the frame header after detecting the signal burst:
moving to fast tracking mode in which a clock loop filter is programed for fast clock convergence and a clock loop is closed;
detecting that the clock is locked;
moving to slow tracking mode in which clock loop filter coefficients programmed for slow changes are used; and
once the signal burst is complete, waiting for a second signal burst.

19. The hub node of claim 15, wherein estimating signal power of the signal burst from the leaf node and compensating for differences in the signal power of the signal burst comprises:
setting gain to a last-known-good gain value for the leaf node;
measuring the signal power during a fast clock recover mode after detection of the signal burst;
setting the gain;
going into slow tracking mode;
measuring the signal power during the payload of the frame; and
updating the gain value.

20. The hub node of claim 15, wherein determining the local oscillator signal Frequency Offset Estimate (FOE), utilizes a local-oscillator signal (Lo-Sig) frequency recovery circuit of the hub node which is configured to:
calculate a phase vector between the signal burst and a known frame-alignment-sequence;
calculate an instantaneous frequency from a phase difference between consecutive phase vectors; and
calculate an average frequency offset by averaging the instantaneous frequency offset over the frame-alignment-sequence.
